(19) United States
(12) Patent Application Publication
(10) Pub. No.: US 2009/0220336 A1
(43) Pub. Date: Sep. 3, 2009

(54) VENTILATION SYSTEM AND METHOD FOR ASSEMBLING THE SAME

(76) Inventors: Richard Lynn Loud, Ballston Spa, NY (US); Carlos Andres Rodriguez, Albany, NY (US); Timothy Andrew Melsert, Ballston Lake, NY (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/041,465

(22) Filed: Mar. 3, 2008

(51) Int. Cl. F01D 1/02; B23P 11/00

(52) U.S. Cl. 415/206; 29/428

(57) ABSTRACT

A method for assembling a ventilation system is provided. The method includes providing a ventilation hood that includes a cover portion and a discharge portion extending from the cover portion. The cover portion includes a first aperture, an opposite second aperture, and a cavity therein, wherein an interior of the discharge portion is in flow communication with the cover portion cavity. The method also includes coupling a rotatable member at least partially within the ventilation hood, such that the rotatable member extends at least partially through at least one of the first and second apertures, and such that rotation of the rotatable member induces a windage-driven flow of fluid between a portion of the rotatable member and at least one of the first and second apertures.

### BACKGROUND OF THE INVENTION

The field of this invention relates generally to ventilation systems, and more particularly, to a method and a system for ventilating a power train enclosure in a power plant.

At least some known power plants include a steam turbine, an electric generator, and a rotatable member, such as a shaft, that couples the steam turbine to the electric generator. In many power plants, the burning of a combustible fuel, such as coal, produces thermal energy that boils water to produce steam. The steam is channeled through the turbine, which converts the thermal energy to mechanical energy by rotating the rotatable member coupling the turbine to the electric generator. The rotation of the rotatable member spins the electric generator to produce electricity.

During operation, rotation of the rotatable member generates heat and noise due to friction between the surfaces of the rotatable member and the surrounding air, and the level of noise can make for unpleasant operating conditions. To facilitate mitigating the noise level, at least some known systems employ an enclosure around the rotatable member. However, although the noise levels may be mitigated, the heat generated as the rotatable member is rotated may, over time, create excessive temperatures within the enclosure.

To facilitate preventing excessive temperatures within the enclosure, at least some known enclosures are ventilated. However, known ventilation systems may require a larger footprint, may increase the costs associated with the assembly, maintenance, and operation of the system, and may decrease the operating efficiency of the system.

### BRIEF DESCRIPTION OF THE INVENTION

In one aspect, a method for assembling a ventilation system is provided. The method includes providing a ventilation hood that includes a cover portion and a discharge portion extending from the cover portion. The cover portion includes a first aperture, an opposite second aperture, and a cavity therein, wherein an interior of the discharge portion is in flow communication with the cover portion cavity. The method also includes coupling a rotatable member at least partially within the ventilation hood, such that the rotatable member extends at least partially through at least one of the first and second apertures, and such that rotation of the rotatable member induces a windage-driven flow of fluid between a portion of the rotatable member and at least one of the first and second apertures.

In another aspect, a ventilation apparatus for use with a rotatable member is provided. The ventilation apparatus includes a hood that has a cover portion and a discharge portion that extends from the cover portion. The cover portion is hollow and defines a cavity therein, and an interior of the discharge portion is coupled in flow communication with the cavity. The cover portion includes an outer surface including at least one of a first aperture and a second aperture defined thereon, wherein at least one of the first and second apertures is capable of receiving a fluid therethrough. The ventilation apparatus also includes a rotatable member extending at least partially through at least one of the first and second apertures such that rotation of the rotatable member induces a windage-driven flow of fluid inward through at least one of the first and second apertures and outward through the discharge portion.

In another aspect, a system for ventilating an area is provided. The system includes a ventilation hood including a cover portion and a discharge portion extending from the cover portion. The cover portion includes a first aperture, an opposite second aperture, and a cavity therein, wherein an interior of the discharge portion is in flow communication with the cover portion cavity. The system also includes a rotatable member coupled at least partially within the ventilation hood, wherein the rotatable member extends at least partially through at least one of the first and second apertures, and wherein rotation of the rotatable member induces a windage-driven flow of fluid between a portion of the rotatable member and at least one of the first and second apertures.

### BRIEF DESCRIPTION OF THE DRAWINGS

FIG. 1 is a perspective schematic view of an exemplary ventilation system;

FIG. 2 is a schematic view of an exemplary ventilation apparatus used with the system shown in FIG. 1; and

FIG. 3 is a cross-sectional view of the exemplary ventilation apparatus shown in FIG. 2.

### DETAILED DESCRIPTION OF THE INVENTION

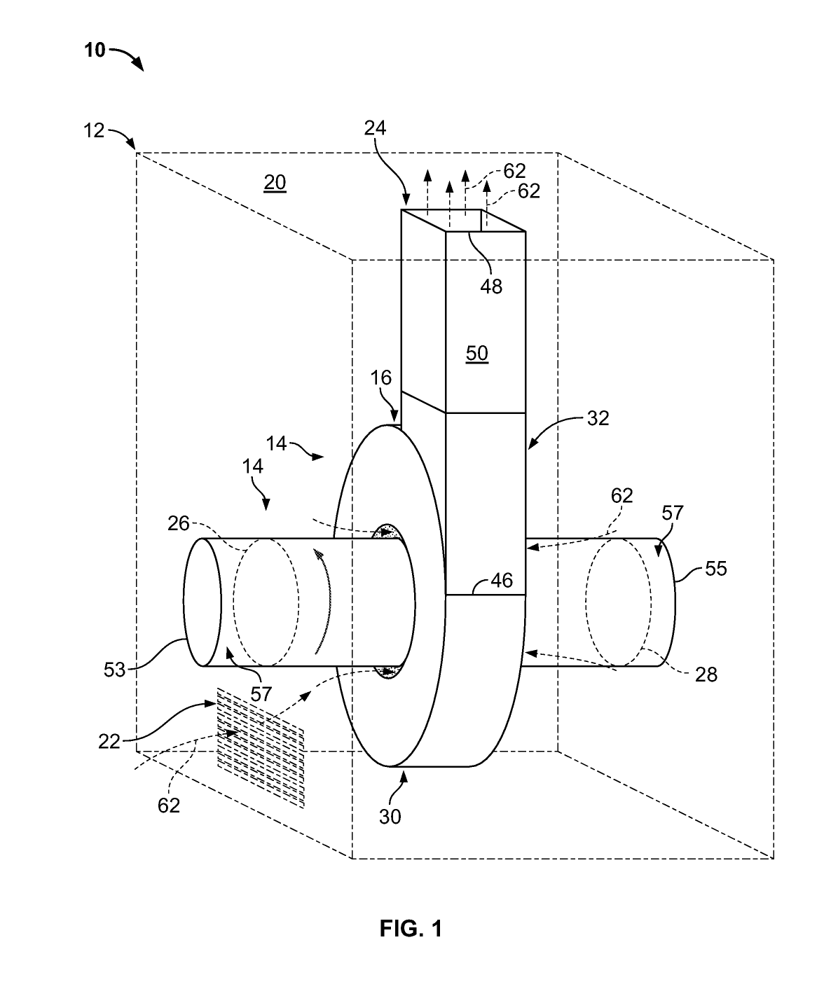

FIG. 1 is a perspective schematic view of an exemplary ventilation system 10. Ventilation system 10 may include an enclosure for any rotatable member, as described herein. For example, ventilation system 10 may include an enclosure for a rotatable member that couples a motor to a pump or may include an enclosure for a rotatable member that couples a gas turbine to a steam turbine. While ventilation system 10 may be designed for use in various mechanical arrangements, in the exemplary embodiment, ventilation system 10 includes an enclosure 12 for a power train (not shown) of a power plant (not shown). Specifically, enclosure 12 at least partially houses a rotatable member 18 that couples together a turbine (not shown) and a load (not shown), such as an electric generator.

Ventilation system 10 includes enclosure 12 and a ventilation apparatus 14. Ventilation apparatus 14 includes a ventilation hood 16 and a rotatable member 18. Enclosure 12, as described in more detail below, facilitates mitigating noise generated by the rotation of rotatable member 18, and ventilation apparatus 14 facilitates ventilating enclosure 12. While enclosure 12 is described herein as facilitating mitigating noise, enclosure 12 may also facilitate various other purposes, such as, for example, weather protection, fire protection, and/or personnel protection. Alternatively, the primary purpose of enclosure 12 may be to facilitate ventilating rotatable member 18.

In the exemplary embodiments, enclosure 12 has a generally rectangular cross-sectional shape. In alternative embodiments, enclosure 12 may have any suitable size or shape that enables system 10 to function as described herein. More specifically, in the exemplary embodiment, enclosure 12 includes an outer wall 20 that includes a first opening 26 and a second opening 28 defined thereon. Openings 26 and 28 are sized to receive at least a portion of rotatable member 18 therethrough. Furthermore, openings 26 and 28 are disposed on opposing sides of enclosure 12, are substantially co-axially aligned, and are substantially symmetrical in size and shape. Alternatively, one of the first opening 26 and the second opening 28 may have a different size, shape, and/or orientation than the other opening 26 or 28. Additionally, in an alternative embodiment, enclosure 12 may not include openings 26 and 28, and rotatable member 18 may be completely housed within enclosure 12. Outer wall 20 also includes an inlet 22 and an outlet 24 defined on adjacent sides of enclosure 12. Inlet 22 and outlet 24 enable a fluid 62 to flow through enclosure 12 from inlet 22 through outlet 24. Alternatively, inlet 22 and outlet 24 may be positioned on opposing sides of enclosure 12 or may be positioned on a single side of enclosure 12. While inlet 22 and outlet 24 are spaced a distance apart on outer wall 20 in the exemplary embodiment, inlet 22 and outlet 24 may be formed together in an alternative embodiment. Additionally, enclosure 12 may include a plurality of inlets 22 and/or a plurality of outlets 24 defined thereon.

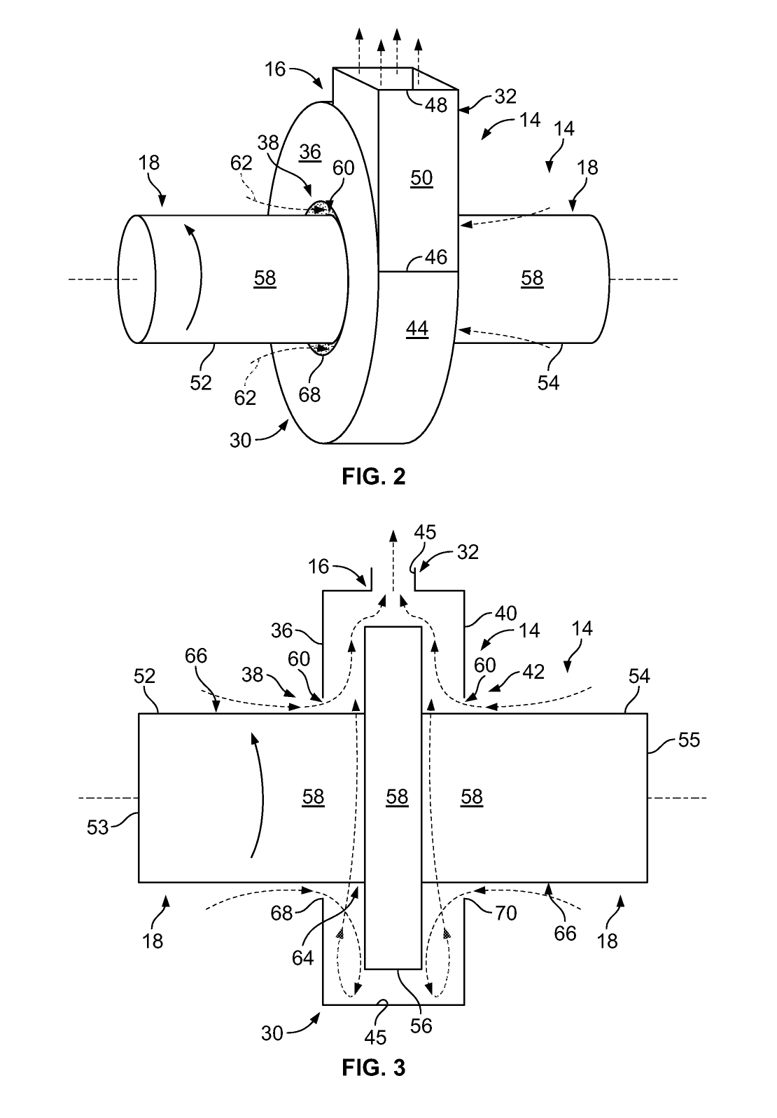

FIG. 2 is a schematic illustration of an exemplary ventilation apparatus 14 that may be used with ventilation system 10 (as shown in FIG. 1), and FIG. 3 is a cross-sectional view of the ventilation apparatus 14 shown in FIG. 2. In the exemplary embodiment, ventilation apparatus 14 includes ventilation hood 16 and rotatable member 18.

As shown in FIG. 2, ventilation hood 16 includes a cover portion 30 and a discharge portion 32, wherein cover portion 30 and discharge portion 32 are hollow. More specifically, cover portion 30 includes a first face 36, an opposite second face 40 (shown in FIG. 3), and a peripheral face 44 that extends between first face 36 and second face 40. First face 36 is substantially parallel to second face 40, and faces 36 and 40 include an aperture 38 and an aperture 42 (shown in FIG. 3), respectively. Alternatively, one of first face 36 and second face 40 may be without respective aperture 38 or 42 and may be substantially solid, such that cover portion 30 includes only one aperture 38 or 42. Moreover, apertures 38 and 42 are generally circular in shape and are substantially concentrically aligned, such that cover portion 30 is generally toroidal and generally symmetrical in shape. Alternatively, cover portion 30 may have any suitable size or shape that enables ventilation hood 16 to function as described herein. Moreover, in an another embodiment, apertures 38 and/or 42 may have any non-circular shape that enables hood 16 to function as described herein.

In the exemplary embodiment, discharge portion 32 includes a first end 46, a second end 48, and a body 50 extending between ends 46 and 48. First end 46 is coupled in flow communication with cover portion 30, and, as shown in FIG. 1, second end 48 is either coupled in flow communication with enclosure outlet 24 or positionable in flow communication with enclosure outlet 24 to enable a fluid 62 to flow from cover portion 30 into discharge portion 32 through first end 46 and to be discharged from discharge portion 32 through second end 48. Although discharge portion 32 has a generally rectangular cross-sectional profile in the exemplary embodiment, discharge portion 32 may have any cross-sectional shape that enables hood 16 to function as described herein. Cover portion 30 and discharge portion 32 are each positioned within enclosure 12, and more specifically, each portion 30 and/or 32 may be coupled within enclosure 12 using any suitable means. Alternatively, second end 48 of discharge portion 32 may extend beyond enclosure outer wall 20.

In another embodiment, an interior surface 45 (shown in FIG. 3) of ventilation hood 16 may include a silencer mechanism (not shown) and/or may be lined with a thermal insulation (not shown) and/or an acoustic insulation (not shown) to facilitate reducing heat dissipation and/or noise propagation. Specifically, the silencer mechanism and/or the acoustic insulation may be positioned within body 50 of discharge portion 32 such that the silencer mechanism and/or the acoustic insulation extends along a portion of interior surface 45 proximate second end 48 or extends from first end 46 to second end 48, such that noise is facilitated being mitigated as fluid 62 exits discharge portion 32 through second end 48.

In the exemplary embodiment, as shown in FIG. 3, rotatable member 18 includes a first shaft 52 extending from a first end 53, a second shaft 54 extending from a second end 55, and a coupler 56 for coupling first shaft 52 to second shaft 54 between first end 53 and second end 55, wherein shafts 52 and 54 have approximately the same diameter and are coupled substantially concentrically together. In an alternative embodiment, rotatable member 18 may include other rotatable components such as, but not limited to, other shafts, at least one sphere, and/or a disc. In the exemplary embodiment, rotatable member 18 has an outer surface 58 that is substantially smooth. Alternatively, at least a portion of outer surface 58 may be configured to generate windage when rotatable member 18 is rotated. More specifically, at least a portion of outer surface 58 may have a predetermined roughness that facilitates increasing windage between outer surface 58 and surrounding fluid 62 during rotation of rotatable member 18. For example, at least a portion of outer surface 58 may be formed with indentations (not shown) or grooves (not shown) that facilitate increasing windage upon rotation of rotatable member 18. Additionally, at least a portion of outer surface 58 may include at least one protuberance (not shown) that extends therefrom, such as, but not limited to, a thread or an impeller coupled to or formed with rotatable member 18. Moreover, in an another embodiment, at least one bolt hole (not shown) may be formed in coupler 56 and at least one bolt head (not shown) and/or nut (not shown) may extend from coupler 56, facilitating coupling first shaft 52 to second shaft 54.

As shown in FIG. 3, in the exemplary embodiment, rotatable member 18 extends through both apertures 38 and 42, such that at least a portion 64 of rotatable member 18 is within ventilation hood 16 and at least a portion 66 of rotatable member 18 is external of ventilation hood 16. More specifically, at least a portion 66 of rotatable member 18 is external of ventilation hood 16 proximate first face 36, and at least a portion 66 of rotatable member 18 is external of ventilation hood 16 proximate second face 40. Alternatively, if cover portion 30 includes only one of apertures 38 and 42, rotatable member 18 may extend through the one aperture 38 or 42, such that one of first end 53 and second end 55 is within cover portion 30 and such that at least a portion 66 of rotatable member 18 is external of cover portion 30. In the exemplary embodiment, coupler 56 rotatably couples first shaft 52 to second shaft 54 within ventilation hood 16. In an alternative embodiment, rotatable member 18 may be a unitary shaft.

In the exemplary embodiment, a first edge 68 and a second edge 70 of cover portion 30 define apertures 38 and 42 respectively, and rotatable member 18 extends through apertures 38 and/or 42 such that a gap 60 separates outer surface 58 of rotatable member 18 from edges 68 and/or 70. As such, fluid 62 is capable of entering cover portion 30 through gap 60.

As shown in FIG. 1, rotatable member 18 extends through first opening 26 and second opening 28 of enclosure 12. More specifically, rotatable member 18 extends through enclosure 12 such that at least a portion 57 (shown in FIG. 1) of rotatable member 18 is external of enclosure 12 on opposing sides of enclosure 12. Alternatively, rotatable member 18 may be completely encased within enclosure 12 or may extend through only one of openings 26 and 28.

Upon rotation of rotatable member 18, as illustrated in FIG. 3, fluid 62 is caused to flow through ventilation hood 16. For example, rotation of rotatable member 18 generates windage between outer surface 58 and surrounding fluid 62 within cover portion 30, such that an area of lower pressure (not shown), when compared to ambient pressure, is formed within cover portion 30, wherein the area of lower pressure (not shown) causes fluid 62 to flow through ventilation hood 16, which causes fluid 62 to enter enclosure 12 through inlet 22. Broadly, the lower pressure (not shown) formed within cover portion 30 by the rotation of rotatable member 18 causes fluid 62 to flow into enclosure 12 through inlet 22, into cover portion 30 through gap 60, through discharge portion 32, and out of enclosure 12 and into the ambient through outlet 24, thereby generating a windage-driven flow of fluid 62 through enclosure 12 in order to ventilate enclosure 12.

In each embodiment, the above-described ventilation methods and systems facilitate ventilating an area. More specifically, in each embodiment, the above-described ventilation apparatus generates a windage-driven airflow through an enclosure in order to facilitate expelling from the enclosure, without the use of supplemental, motor-driven ventilation fans and the like, fluid and heat therein. Accordingly, the above-described methods and systems facilitate cooling the interior of a power train enclosure in a power plant and expelling any unwanted fluids from within the enclosure, while reducing energy costs associated with ventilating the enclosure by eliminating the need for supplemental, motor-driven ventilation systems.

Exemplary embodiments of ventilation methods and systems are described above in detail. These ventilation methods and systems are not limited to the specific embodiments described herein, but rather, components of the methods and systems may be utilized independently and separately from other components described herein. For example, the ventilation apparatus described above may have other industrial or consumer applications and is not limited to practice with energy systems alone, as described herein. Rather, the present invention may be implemented and utilized in connection with many other products and systems.

While the invention has been described in terms of various specific embodiments, those skilled in the art will recognize that the invention can be practiced with modification within the spirit and scope of the claims.

What is claimed is:

1. A method for assembling a ventilation system, said method comprising:
providing a ventilation hood that includes a cover portion and a discharge portion extending from the cover portion, the cover portion including a first aperture, an opposite second aperture, and a cavity therein, wherein an interior of the discharge portion is in flow communication with the cover portion cavity; and
coupling a rotatable member at least partially within the ventilation hood, such that the rotatable member extends at least partially through at least one of the first and second apertures, and such that rotation of the rotatable member induces a windage-driven flow of fluid between a portion of the rotatable member and at least one of the first and second apertures.

2. A method in accordance with claim 1, further comprising providing an enclosure, the enclosure including an outer wall that includes an inlet, an outlet, a first opening, and a second opening, wherein the rotatable member extends at least partially through the first and second openings and wherein rotation of the rotatable member induces a windage-driven flow of fluid through at least one of the first and second openings.

3. A method in accordance with claim 1, wherein providing a rotatable member further comprises providing a rotatable member that includes a shaft, wherein at least a portion of the shaft is positioned within the cover portion.

4. A method in accordance with claim 1, wherein providing a rotatable member further comprises providing a rotatable member that includes a coupler, wherein at least a portion of the coupler is rotatably coupled within the cover portion.

5. A method in accordance with claim 1, wherein providing a rotatable member further comprises providing a rotatable member including a surface configured to generate windage when the rotatable member is rotated.

6. A method in accordance with claim 1, wherein providing a rotatable member further comprises providing a rotatable member that includes at least one protuberance extending therefrom.

7. A method in accordance with claim 1, wherein providing a ventilation hood further comprises providing a ventilation hood wherein the first and second apertures are substantially symmetrical.

8. A ventilation apparatus for use with a rotatable member, said ventilation apparatus comprising:
a hood comprising a cover portion and a discharge portion that extends from said cover portion, said cover portion is hollow and defines a cavity therein, an interior of said discharge portion is coupled in flow communication with said cavity, said cover portion comprises an outer surface comprising at least one of a first aperture and a second aperture defined thereon, at least one of said first and second apertures capable of receiving a fluid therethrough; and
a rotatable member extending at least partially through at least one of said first and second apertures such that rotation of said rotatable member induces a windage-driven flow of fluid inward through at least one of said first and second apertures and outward through said discharge portion.

9. An apparatus in accordance with claim 8, wherein said rotatable member comprises a shaft at least partially positioned within said cover portion.

10. An apparatus in accordance with claim 8, wherein said rotatable member comprises a coupler, wherein at least a portion of said coupler is rotatably coupled within said cover portion.

11. An apparatus in accordance with claim 8, wherein said rotatable member comprises a surface configured to generate windage when said rotatable member is rotated.

12. An apparatus in accordance with claim 8, wherein said rotatable member comprises at least one protuberance extending therefrom.

13. An apparatus in accordance with claim 8, wherein said first and second apertures are substantially symmetrical.

14. A system for ventilating an area, said system comprising:
a ventilation hood comprising a cover portion and a discharge portion extending from said cover portion, said cover portion comprising a first aperture, an opposite second aperture, and a cavity therein, wherein an interior of said discharge portion is in flow communication with said cover portion cavity; and
a rotatable member coupled at least partially within said ventilation hood, said rotatable member extending at least partially through at least one of said first and second apertures, wherein rotation of said rotatable member induces a windage-driven flow of fluid between a portion of said rotatable member and at least one of said first and second apertures.

15. A system for ventilating an area in accordance with claim 14, said system further comprising an enclosure, wherein the enclosure comprises an outer wall comprising an inlet, an outlet, a first opening, and a second opening, said rotatable member extending at least partially through said first and second openings and wherein rotation of said rotatable member induces a windage-driven flow of fluid through at least one of said first and second openings.

16. A system for ventilating an area in accordance with claim 14, said rotatable member comprising a shaft, wherein at least a portion of said shaft is positioned within said cover portion.

17. A system for ventilating an area in accordance with claim 14, said rotatable member comprising a coupler, wherein at least a portion of said coupler is rotatably coupled within said cover portion.

18. A system for ventilating an area in accordance with claim 14, said rotatable member further comprising a surface configured to generate windage when said rotatable member is rotated.

19. A system for ventilating an area in accordance with claim 14, said rotatable member comprising at least one protuberance extending therefrom.

20. A system for ventilating an area in accordance with claim 14, wherein said first and second apertures are substantially symmetrical.
